(19) United States
(12) Patent Application Publication
(10) Pub. No.: US 2006/0078840 A1
(43) Pub. Date: Apr. 13, 2006

(54) Dental orthotic for management of impaired oral functions

(76) Inventor: Farrand C. Robson, Tacoma, WA (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/962,004

(22) Filed: Oct. 8, 2004

(51) Int. Cl. A61C 3/00

(52) U.S. Cl. 433/6

(57) ABSTRACT

An apparatus and method for addressing specific physiological symptoms through distinct combinations of jaw alignment, tongue and teeth interaction is described. A dental orthotic comprising a mandibular orthotic conforming to an user's mandibular dentition used for advancing a jaw of an user forward includes a plurality of contours for adjusting the tongue/teeth interaction, and may also include extensions for positioning the user's tongue. The plurality of contours are designed and applied to specific locations on the orthotic and extensions to promote a desired response for a specific physiological symptoms. The oral contours may include specific shapes such as protrusions, depressions, and grooves. The dental orthotic may also include a maxillary orthotic which is affixed to an upper surface of the mandibular orthotic. The contours change the shape of the mandibular orthotic as well as the dental shapes within the mouth, resulting in repositioning of the tongue and tissue of the throat, thereby improving the oral functions as well as relieving neuromuscular responses and autonomic nervous system dysfunctions.

### FIELD OF THE INVENTION

The present invention generally relates to an apparatus and method for preventing, or greatly reducing, impaired oral functions. In particular, the present invention relates to an oral appliance, such as a dental orthotic, for positioning the jaw forward and treatment of other body compensations.

### BACKGROUND OF THE INVENTION

In the past, oral appliances have been used to treat and relieve upper airway disorders. Such airway disorders usually involved symptoms associated with impairment of the primary oral functions of swallowing, speaking, and breathing, as well as other related problems such as obstructive sleep apnea (OSA) and snoring. For example, an oral orthotic having top and bottom trays shaped to conform to a patient's dentition has been used to reduce symptoms. The orthotic comprises an elastic band releasably attached to retention hooks on the top and bottom trays and functions by pulling the jaw forward to alleviate the oral and sleeping disorders.

The symptoms associated with impairments of the primary oral functions discussed above can be a result of the diminished function itself as well as from body compensations such as musculoskeletal compensations that are initiated to support the primary oral functions through maintenance of the throat and oral functions. Neuromuscular responses and autonomic nervous system dysfunctions are frequently present and may manifest in a variety of ways.

In this regard, a large variety of symptoms can be associated with impaired oral functions. These symptoms may include muscular pain of the head, face, neck, back and any muscular component associated with the forward head posture related to impaired oral functions, for example, many of the full body effects that have been associated with Temporomandibular Joint (TMJ) concerns. Additionally, autonomic nervous system symptoms such as elevated heart rate, on edge or stress like feelings, cold or warm hands and feet, digestive symptoms, visual changes, sinus and nasal dysfunctions as well as many other symptoms may be associated with upper airway disorders.

No known oral orthotic has been designed to manage the symptoms of upper airway disorders as well as manage other neuromuscular reflexes involving the tongue. It would be an improvement in the art to provide an oral appliance that addresses specific symptoms by precise manipulation, design and shaping of the oral appliance. The oral contribution to the neuromuscular control of the throat reduces the need of the other body compensations, including the posture changes and autonomic nervous system symptoms and may reduce symptoms of the diminished function.

Therefore, for the reasons stated above, there is currently a need for a dental orthotic that is an effective treatment for specific neuromuscular responses and autonomic nervous system symptoms, easy to assess and has long lasting use, such as that provided by the present invention described below.

### OBJECTS AND SUMMARY OF THE INVENTION

It is therefore an object of the present invention to provide a dental orthotic that overcomes the shortcomings of prior art oral appliances.

It is another object of the present invention to provide a dental orthotic that is an effective treatment for upper airway disorders as well as neuromuscular responses, and specific autonomic nervous system symptoms.

It is a further object of the present invention to provide a dental orthotic for treating neuromuscular responses and autonomic nervous system symptoms where the orthotic includes contours which adjust a user's tongue and teeth interaction.

It is yet another object of the present invention to provide a dental orthotic that moves the tongue and jaw forward which results in the muscles in the rest of body relaxing, thus relieving symptoms and other discomforts.

It is another object of the present invention to provide a dental orthotic that corrects the posture of the user.

It is still a further object of the present invention to provide a dental orthotic which offers increased comfort because no retention hooks or elastic bands are necessary to move the tongue and jaw forward.

It is yet a further object of the present invention to provide a dental orthotic with high patient acceptance and treatment success for a long period of time.

It is another object of the present invention to provide a method for treating neuromuscular responses and autonomic nervous system symptoms with an orthotic having contours which adjust a user's tongue and teeth interaction.

In accordance with the above objectives, the present invention provides an apparatus and method for positioning the jaw forward and treatment of other body compensations. In a preferred embodiment, an oral appliance for addressing specific physiological symptoms through distinct combinations of jaw alignment and/or tongue and teeth interaction is provided. The oral appliance includes a dental orthotic for advancing a jaw of an user forward. The dental orthotic comprises a mandibular orthotic conforming to the user's mandibular dentition and having a first side portion and a second side portion. Extensions for positioning the user's tongue are provided so that the user's tongue rests on upper surfaces of the extensions. At least one extension extends from one of the first side portion and the second side portion.

The mandibular orthotic includes a plurality of contours designed and applied to specific locations on the orthotic to promote a desired response for a specific physiological symptom by adjusting the tongue/teeth interaction. The oral contours may include specific shapes such as protrusions, depressions, and grooves (i.e. conforming to the shapes/sides of teeth). The oral contours are positioned on an outer surface of the first side portion and the second side portion of the mandibular orthotic, and may also be positioned on the extensions.

The shapes of teeth and tissues in the mouth that contact the tongue may cause muscle contraction in the tongue, thereby affecting the positioning of the tongue and tissue in the throat. The oral contours are made and fitted by selectively adjusting the mandibular orthotic or by adding a material, such as acrylic, to the mandibular orthotic so that it is built up at specific locations. Similarly, in areas where there is excessive enlargement on the mandibular orthotic, the size of the contours may be decreased.

The dental orthotic may also include a maxillary orthotic which is affixed to an upper surface of the mandibular orthotic. The maxillary orthotic includes a first side portion which is positioned on a first side of an upper arrangement of teeth of the user's mouth and a second side portion which is positioned on a second side of the upper arrangement of teeth of the user's mouth. The maxillary orthotic engages the most posterior two or three teeth of the upper arrangement of teeth.

The maxillary orthotic may be affixed to the mandibular orthotic via adhesive to achieve more extensive forward movement of the tongue and jaw in relation to the upper teeth and throat of the user. The first side portion and the second side portion of the maxillary orthotic may also include contours for adjusting the tongue/teeth interaction.

The contours change the shape of the orthotic as well as the dental shapes within the mouth, resulting in repositioning of the tongue and tissue of the throat, thereby improving the oral functions as well as relieving neuromuscular responses and autonomic nervous system dysfunctions. There are presently specific mandibular relationships, that if altered by using the contours, may provide therapeutic benefits and decreased need of body compensations by certain muscles.

A diagnostic system for assessing upper airway disorders and physiological symptoms may also be utilized in designing and fitting the dental orthotic. The diagnostic system aids in the process of custom fitting the user's dentition and optimizes the effectiveness of the dental orthotic for each user. It is believed that the use of the apparatus provided in accordance with the present invention may also result in other benefits.

### BRIEF DESCRIPTION OF THE DRAWINGS

A more complete appreciation of the present invention and many of the attendant advantages thereof will be readily understood by reference to the following detailed description when taken in conjunction with the accompanying drawings, in which:

FIG. 1 is a top plan view showing a first embodiment of an oral appliance, particularly a mandibular orthotic, according to the present invention;

FIG. 2 is a perspective view showing the oral appliance of FIG. 1, engaging a lower dentition of a user's mouth according to the present invention;

FIG. 3 is a cross-sectional side view showing the oral appliance of FIGS. 1 and 2, engaging a lower dentition of the user's mouth according to the present invention;

FIG. 4 is a top plan view showing of a second embodiment of oral appliance, particularly the mandibular orthotic connected to a maxillary orthotic according to the present invention;

FIG. 5 is a perspective view showing the oral appliance of FIG. 4, engaging the lower dentition of the user's mouth according to the present invention; and

FIG. 6 is a cross-sectional side view showing the oral appliance of FIGS. 4 and 5, engaging the dentition of the user's mouth according to the present invention.

### DETAILED DESCRIPTION OF THE INVENTION

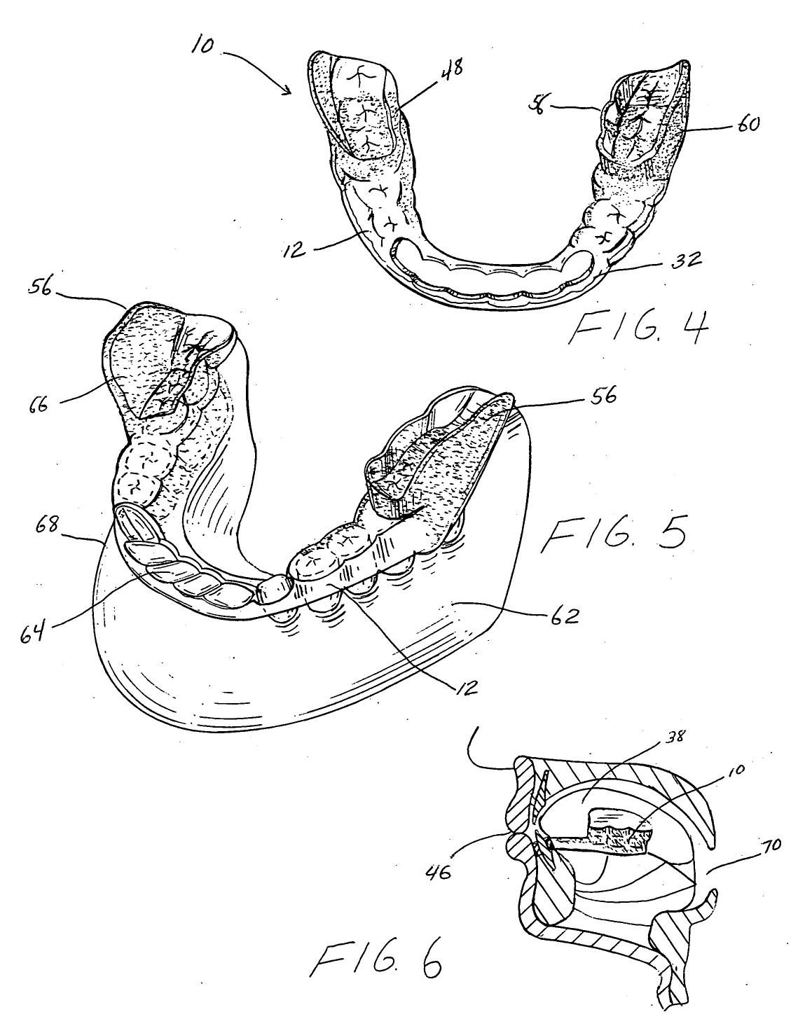

The invention will now be described with reference to FIGS. 1 to 6, which in general discloses embodiments of an oral appliance for addressing specific physiological symptoms through distinct combinations of jaw alignment, and/or tongue and teeth interaction. The oral appliance comprises a dental orthotic 10 which is placed over and conforms to an user's dentition, or arrangement of lower and upper teeth.

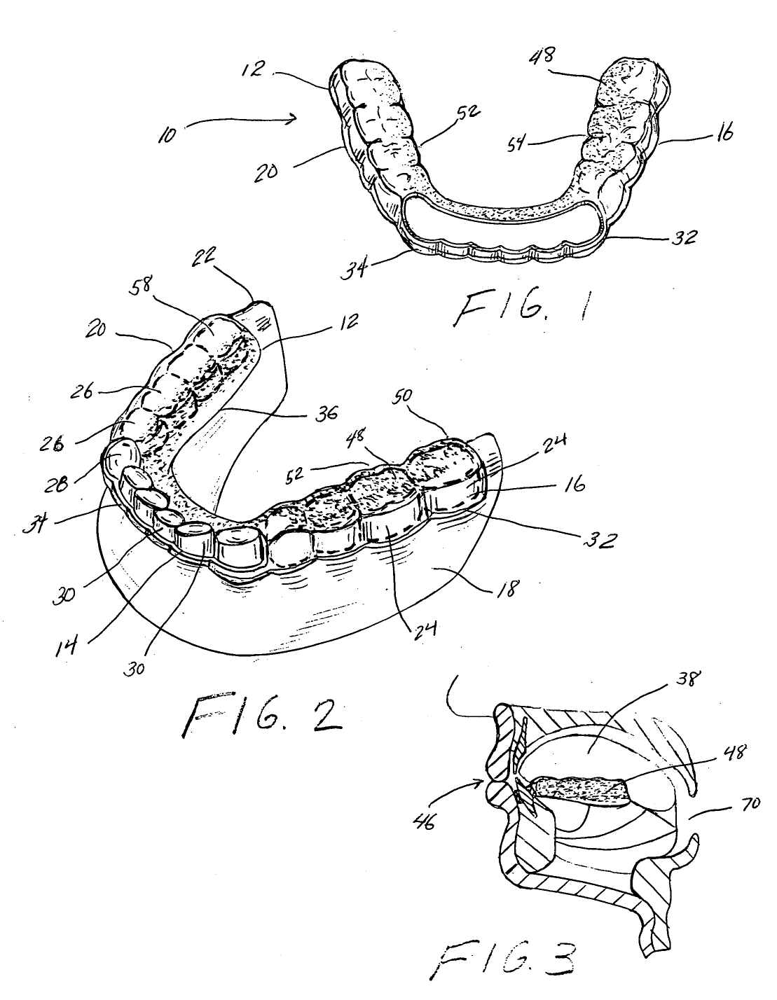

Referring to FIGS. 1 and 2, in a first embodiment a dental orthotic 10 comprises a mandibular orthotic 12 which is configured to engage a lower arrangement of teeth, or lower dentition 14, of a user's mouth. The mandibular orthotic 12 includes a first side portion 16 which is positioned on a first side 18 of the lower arrangement of teeth of the user's mouth and a second side portion 20 which is positioned on a second side 22 of the lower arrangement of teeth of the user's mouth. The first side portion 16 and the second side portion 20 may be placed preferably over molars 24, bicuspids 26, cuspids 28 and incisors 30 in the lower arrangement of teeth 14. However, it is understood that the first side portion and the second side portion are designed to conform to at least one tooth on each side of the user's lower arrangement of teeth.

The mandibular orthotic 12 is preferably made of a pliable material, such as plastic, which can be molded to the user's teeth when being made and fitted. As shown in FIGS. 1 and 2, a wire 32 preferably made of metal may be added to a front portion 34 and between the first side portion 16 and the second side portion 20 of the mandibular orthotic 12. The wire 32 provides strength and adds to the longevity of use of the mandibular orthotic. The front portion may also aid in raising a user's tongue 38, as illustrated in FIG. 3.

As shown in FIG. 2, the mandibular orthotic 12 may include extensions 36 which position a user's tongue 38 so that the user's tongue rests on an upper surface of the extensions. The extensions 36 are provided below the first side portion 16 and the second side portion 20 and near a lingual side of the mandibular orthotic 12 such that the extensions are lying next to and under the tongue 38. An inner side of each extension has a convex shape at a central region which when positioned beneath the tongue, elevates and advances the tongue forward toward a front 46 of a user's mouth. The extensions may be designed to conform to soft tissue on a floor of the user's mouth. The extensions 36 are also preferably made of plastic and molded as an addition to the mandibular orthotic 12 described above which is molded to fit selected teeth of the user. It is understood that a depth of the extensions may extend further down into the floor of the user's mouth and is dependent upon the size and shape of the user's mouth as long as the user does not experience impinging on tissue or other discomfort. It is also understood that at least one extension is provided and extends from one of the first side portion or the second side portion of the mandibular orthotic.

The mandibular orthotic 12 includes a plurality of oral contours 48 (shown dotted on FIGS. 1-6) which may be manipulated and shaped at precise locations during a user's fitting of the mandibular orthotic. The oral contours address specific physiological symptoms in the user through distinct combinations of jaw alignment, tongue and teeth interaction. The oral contours 48 may include specific shapes such as protrusions 50, depressions 52, and grooves 54 (i.e. conforming to the shapes/sides of teeth). The oral contours 48 are positioned on an inner surface of the first side portion and the second side portion of the mandibular orthotic 12, and may also be positioned on the extensions 36.

The shapes of teeth and tissues in the mouth that contact the tongue may cause muscle contraction in the tongue, thereby affecting the positioning of the tongue, teeth and tissue in the throat. The oral contours 48 are made and fitted by selectively adjusting the mandibular orthotic 12 or by adding a material, such as acrylic, to the mandibular orthotic so that it is built up at specific locations. Similarly, in areas where there is excessive enlargement on the mandibular orthotic 12, the size of the contours 48 may be decreased. The contours change the shape of the mandibular orthotic as well as the dental shapes within the mouth, resulting in repositioning of the tongue and tissue of the throat, thereby improving the oral functions as well as relieving neuromuscular responses and autonomic nervous system dysfunctions.

There are presently specific mandibular relationships, that if altered by using the contours, may provide therapeutic benefits and decreased need of body compensations by certain muscles. For example, listed below is the relationship between the region of the user's mouth and areas of the body where muscle contraction causing pain may occur due to impaired oral functions.

First molar=shoulder and temple areas,

Second Bicuspid=one-third down the upper half of the back from the shoulder to the mid back,

First Bicuspid and Cuspid=two-thirds down the upper half of the back from the shoulder to the mid back, and

Lateral and Central Incisors=the posterior mid back region at the level of the diaphragm.

Areas of muscle contraction symptoms may be controlled if adjacent muscle groups are well balanced through alteration of the dental orthotic. The following conditions, including enlarging or decreasing the thickness, shape and position of the contour on the dental orthotic are taken into consideration when the dental orthotic is being fitted and made:

(1) When the user's tongue is not free to move up out of the throat and into the mouth, muscle contractions may occur and lead to pain stimulated in specific locations of the head, neck, shoulder and/or upper back. Enlarging a contour may position the tongue to an opposite side of the mouth and allow the tongue to freely move up from the throat into the mouth.

(2) When the jaw of the user is positioned to one side, the user's tongue may not freely move to the opposite side of the mouth. Muscle contractions may occur and lead to pain stimulated in the head, neck, shoulder and upper back on the same side that the jaw is positioned. If the dental bite of the user contacts on one side, the jaw muscles on the opposite side may have increased muscle contraction too.

(3) When the tongue is prevented from moving over occlusal surfaces (i.e. the grinding surface) of the bicuspid teeth, there may be discomfort in the hip area of the opposite side. Hand pain may also occur under these circumstances.

(4) When the tongue does not freely pass over the first molar on a side of the mouth, there may be discomfort in the most inferior portion of the web of muscle between the thumb and first finger, and in the mid neck area on the opposite side of the body. There may also be hand pain such as thumb muscle tightness.

(5) When the tongue does not rest on the occlusal of the second bicuspid, thumb muscle tightness and/or pain may be present and superior to the region stimulated by the first molar. There may also be discomfort in the upper neck on the opposite side.

(6) When the tongue does not rest on the occlusal and lingual surfaces the first bicuspid and cuspid, there may be thumb muscle tightness and/or pain superior to the region stimulated by the second bicuspid. There may also be discomfort in the neck near the base of the skull on the opposite side.

(7) When the orthotic has excessive thickness in the region inferior to the molars and second bicuspid, discomfort in the anterior thigh and knee area may be present.

(8) When the dental orthotic is enlarged on the second molar and movement of the tongue is restricted, excessive lateral head tilt to the same side and diminished effectiveness of the teeth and structure anterior to the second molar may be present. An enlarged orthotic on the second molar may also result in elevation of the tongue to the soft palate. Nasal and sinus symptoms on the same side, gagginess and a reduction of the normal throat dimension in the hypopharynx may result as well. There may also be nerve like symptoms below the eye on the same side, pressure and pain in the lateral posterior skull on the opposite side and lateral posterior neck pain in the lower half of the neck on the opposite side.

(9) When the tongue is restricted from moving past the most posterior portion of the second molar, there may be same side discomfort in the upper back just below the crest of the shoulder and immediately lateral.

(10) When a contour is enlarged near a mid molar area at the greatest height of the tooth near the occlusal surface of the tooth, reduction of muscle contraction pain at the top of the shoulder and immediately to the same side of the midline results. Temple and sub occipital discomfort also frequently relate to this region and resolves as the tongue is directed more anteriorly. Therefore, it is imperative that movement of the tongue anteriorly is not impaired by the mandibular anterior region.

(11) When contours in the area anterior and inferior to the first molar is excessively thick, muscle tightness in the shoulder on the opposite side and difficulty with elevation of the shoulder may be present.

(12) When contours have excessive thickness in the area below the bicuspids and cuspid, discomfort on the ulnar side of the hand and wrist may be present. The more posterior the oral area, the more superior the ulnar side forearm pain up to the elbow may exist.

(13) When contours have excessive thickness in the region inferior to the molars and second bicuspid near the back teeth, discomfort to the anterior thigh and knee area may be present.

It is understood that contours are molded as an addition to the mandibular orthotic described above which is molded to fit selected teeth of the user. The oral contours may include one contour or a plurality of contour shapes as long as the contours are provided in a manner that allows specific physiological symptoms to be addressed. The relationships between contours and specific muscle groups is not limited to those discussed above. Furthermore, depending on the user's symptoms being treated, the mandibular orthotic may be designed with only contours and no extensions.

Referring to FIGS. 4 to 6, in a second embodiment the dental orthotic 10 of the present invention may also include a maxillary orthotic 56 which is affixed to an upper surface 58 of the mandibular orthotic 12. The maxillary orthotic 56 includes a first side portion 60 which is positioned on a first side 62 of an upper arrangement of teeth, or upper dentition 64, of the user's mouth and a second side portion 66 which is positioned on a second side 68 of the upper arrangement of teeth 64 of the user's mouth. Preferably, the first side portion 60 and the second side portion 66 are placed over an outer surface of the upper arrangement of teeth and also extend over a biting surface of the teeth. The maxillary orthotic 56 engages the most posterior two or three teeth of the upper arrangement of teeth 64. Depending on the teeth present in the user's mouth, the teeth covered are typically a second bicuspid, a first molar and a second molar. However, it is understood that the first side portion and the second side portion are designed to conform to at least one tooth on each side of the user's upper arrangement of teeth.

The maxillary orthotic 56 may be affixed to the mandibular orthotic 12 to achieve more extensive forward movement of the tongue and jaw in relation to the upper teeth and throat of the user. The mandibular orthotic 12 is generally placed forward relative to the position of the maxillary orthotic 56 in an advanced position which opens the airway 70 of the user and the user's bite vertically. The maxillary orthotic also directs the user's tongue into appropriate contact with the user's lower jaw. The maxillary orthotic 56 may be securely affixed to the mandibular orthotic using an adhesive substance that securely bonds two materials together by adhering to each other, preferably an acrylic.

Similar to the mandibular orthotic, as shown in FIGS. 4 and 5, the maxillary orthotic 56 may include contours 48 on the first side portion 60 and the second side portion 66. The contours 48 located on the first side portion and the second side portion of the maxillary orthotic 56, and therefore near the upper jaw, direct the tongue into an appropriate relationship with the lower arrangement of teeth and the lower jaw. For example, upper central incisors must not have excessive functional contact with the tongue near the midline, which is a plane through the very center of the user's mouth perpendicular to the nose. The lateral incisors must allow for passage of the tongue forward and downward. The first bicuspids' lingual surfaces are positioned more lingually than the second bicuspids and direct the tongue to the inferior in this region, as does the gingival portion of the cuspid. The second bicuspids are therefore more laterally positioned and allow for passage of the tongue. Contours on the lingual surfaces of the first molars may also be used to direct the tongue downward.

The dental orthotic, with the addition of the extensions and contours, may be polished so that the user does not experience any discomfort when wearing the orthotic, such as impinging on the floor of the user's mouth or a lateral surface of the user's tongue. It is understood that the size and shape of the dental orthotic may vary from user to user.

A diagnostic system for assessing upper airway disorders and physiological symptoms may be utilized in designing and fitting the dental orthotic 10. The diagnostic system aids in the process of custom fitting the user's dentition and optimizes the effectiveness of the dental orthotic for each user.

Evaluation of the user is performed by taking a highly specialized history of the user and the symptoms the user is experiencing at an initial office visit. Some user's experience obvious impairments of jaw functions evidenced by their speech, swallowing, eating and breathing characteristics. However, in other individuals these functions above appear normal despite experiencing significant muscle and joint dysfunctions. Therefore, the history is designed to reveal deficits in oral functions, especially apparently minor impairments in the jaw's contribution to breathing, swallowing and speaking.

Radiographs, Video Fluoroscope and Magnetic Resonance Imaging (MRI) may used to provide valuable information about the oral function of a user before fitting and treatment with the dental orthotic. For example, an imaging may reveal that a user's tongue blocks the throat and an epiglottis is obscured by a hyoid bone.

To assist in the evaluation of the dental orthotic 10 and determining if symptoms are relieved, temporary wax is affixed to the dental orthotic 10 in the shape of the extensions 36 and contours 48. The wax and dental orthotic is then covered with pressure indicating paste and the user is encouraged to perform oral functions such as speaking, eating, swallowing, and breathing. After performance of the oral functions are completed, the dental orthotic is removed and the pressure indicating paste is assessed for areas that require removal or build up of wax. The adjustments are made to the dental orthotic and the performance of oral functions are repeated until appropriate pressure is achieved on the area corresponding to the specific characteristics of the symptom being addressed.

Imaging may again be used to view the user's oral function after treatment using the dental orthotic to determine whether the symptoms have been alleviated. The preferred resulting view is that any contact with the tongue is passive. Once the final adjustments have been made to the dental orthotic and the fitting of the user is completed, the temporary wax on the dental orthotic may be replaced by plastic.

The dental orthotic of the present invention is an effective treatment for upper airway disorders and specific neuromuscular responses and autonomic nervous system symptoms. These symptoms may include muscular pain of the head, face, neck, back, shoulder, hip, knee, elbow, hand and any muscular component associated with the forward head posture related to impaired oral functions, for example, many of the full body effects that have been associated with Temporomandibular Joint (TMJ) concerns. Additionally, autonomic nervous system symptoms such as elevated heart rate, fatigue, on edge or stress like feelings, cold or warm hands and feet, digestive symptoms, visual changes, fight or flight effects, disturbed sleep, sinus and nasal dysfunctions as well as many other symptoms may be associated with upper airway disorders. The dental orthotic moves the tongue and jaw forward which results in the muscles in the rest of body relaxing, thus relieving symptoms and other discomforts. The dental orthotic also corrects the posture of the user. The dental orthotic has high patient acceptance, increased comfort and treatment success for a long period of time.

Although the oral appliance is shown in FIGS. 1 to 6 with the dental orthotic described above, it is understood and within the scope of the present invention that the features of the present invention may be used with any conventional oral appliance, such as orthotics that use retention hooks and elastic bands, as well as day and night time orthotics. Thus, the present invention is not limited to the features and embodiments described above.

What is claimed:

1. An oral appliance for addressing specific physiological symptoms through distinct combinations of jaw alignment, tongue and teeth interaction comprising:
an orthotic for conforming to an user's dentition; and
a plurality of contours; wherein the plurality of contours are designed and applied to specific locations on the orthotic.

2. The oral appliance according to claim 1, wherein the plurality of contours may include a specific shape of a depression.

3. The oral appliance according to claim 1, wherein the plurality of contours may include a specific shape of a protrusion.

4. The oral appliance according to claim 1, wherein the plurality of contours may include a specific shape of a groove.

5. The oral appliance according to claim 1, wherein the orthotic has a first side portion and a second side portion; the first side portion is positioned on a first side of the mandibular dentition and the second side portion is positioned on a second side of the mandibular dentition.

6. The oral appliance according to claim 5, further comprising extensions on the orthotic; wherein the extensions are provided below the first side portion and the second side portion and near a lingual side of the orthotic such that the extensions are lying next to and under the tongue.

7. The oral appliance according to claim 1, wherein the oral appliance includes a maxillary orthotic affixed to an upper surface of a mandibular orthotic.

8. The oral appliance according to claim 1, wherein the plurality of contours may include a contour placed on the orthotic near a bicuspid.

9. The oral appliance according to claim 8, wherein placing the contour near the bicuspid relieves discomfort in one or more of the following body areas: neck, upper back, hip, thigh, knee, elbow, forearm, wrist, hand and thumb.

10. The oral appliance according to claim 1, wherein the plurality of contours may include a contour placed on the orthotic near a cuspid.

11. The oral appliance according to claim 10, wherein placing the contour near the cuspid relieves discomfort in one or more of the following body areas: upper back, elbow, forearm, wrist, hand and thumb.

12. The oral appliance according to claim 1, wherein the plurality of contours may include a contour placed on the orthotic near a molar.

13. The oral appliance according to claim 12, wherein placing the contour near the molar relieves discomfort in one or more of the following body areas: skull, temple, eye, nasal and sinus symptoms, gagginess, reduction of throat dimension, neck, upper back, shoulder, thigh, knee, thumb.

14. The oral appliance according to claim 1, wherein the plurality of contours may include a contour placed on the orthotic near an incisor.

15. The oral appliance according to claim 14, wherein placing the contour near the incisor relieves discomfort in a posterior mid back region at a level of a diaphragm.

16. The oral appliance according to claim 1, wherein the plurality of contours includes at least one contour enlarged to allow a tongue to move freely in a mouth of the user relieving pain stimulated in a head, a neck, a shoulder and/or an upper back of a user.

17. An oral appliance for addressing physiological symptoms through adjustment of tongue and teeth interaction comprising:
an orthotic for conforming to a's mandibular dentition including at least an inner surface; and
wherein regions of the inner surface include contours to manage impaired oral functions.

18. An oral appliance for addressing specific physiological symptoms through distinct combinations of jaw alignment, tongue and teeth interaction comprising:
an orthotic for advancing a jaw of an user forward, the orthotic conforming to the user's mandibular dentition and having a first side portion and a second side portion;
at least one extension for positioning the user's tongue so that the user's tongue rests on an upper surface of the extensions; said at least one extension extending from one of the first side portion and the second side portion; and,
a plurality of contours; wherein the plurality of contours are designed and applied to specific locations on the orthotic and extensions to promote a desired response for a specific physiological symptom.

19. The oral appliance according to claim 18, wherein the plurality of contours includes at least one contour placed on the orthotic near a bicuspid.

20. The oral appliance according to claim 19, wherein placing the contour near the bicuspid relieves discomfort in one or more of the following body areas: neck, upper back, hip, thigh, knee, elbow, forearm, wrist, hand and thumb.

21. The oral appliance according to claim 18, wherein the plurality of contours may include a contour placed on the orthotic near a cuspid.

22. The oral appliance according to claim 21, wherein placing the contour near the cuspid relieves discomfort in one or more of the following body areas: upper back, elbow, forearm, wrist, hand and thumb.

23. The oral appliance according to claim 18, wherein the plurality of contours may include a contour placed on the orthotic near a molar.

24. The oral appliance according to claim 23, wherein placing the contour near the molar relieves discomfort in one or more of the following body areas: skull, temple, eye, nasal and sinus symptoms, gagginess, reduction of throat dimension, neck, upper back, shoulder, thigh, knee, thumb.

25. The oral appliance according to claim 18, wherein the plurality of contours may include a contour placed on the orthotic near an incisor.

26. The oral appliance according to claim 25, wherein placing the contour near the incisor relieves discomfort in a posterior mid back region at a level of a diaphragm.

27. The oral appliance according to claim 18, wherein the plurality of contours includes at least one contour enlarged to allow a tongue to move freely in the user's mouth relieving pain stimulated in a head, a neck, a shoulder and/or an upper back of a user.

28. The oral appliance according to claim 18, wherein the oral appliance includes a maxillary orthotic affixed to an upper surface of the orthotic conforming to the user's mandibular dentition.

29. The oral appliance according to claim 18, wherein the plurality of contours may include a specific shape of a depression.

30. The oral appliance according to claim 18, wherein the plurality of contours may include a specific shape of a protrusion.

31. The oral appliance according to claim 18, wherein the plurality of contours may include a specific shape of a groove.

32. A method for designing an orthotic to alleviate physiological symptoms of a user comprising the steps of:
assessing impaired oral function of the user; and
constructing an orthotic having contours to reposition a tongue of the user.

33. The method according to claim 32, wherein the contours may include a specific shape of a depression.

34. The method according to claim 32, wherein the contours may include a specific shape of a protrusion.

35. The method according to claim 32, wherein the contours may include a specific shape of a groove.

36. The method according to claim 32, wherein the orthotic has a first side portion and a second side portion; the first side portion is positioned on a first side of a mandibular dentition and the second side portion is positioned on a second side of the mandibular dentition.

37. The method according to claim 36, further comprising extensions on the orthotic; wherein the extensions are provided below the first side portion and the second side portion and near a lingual side of the orthotic such that the extensions are lying next to and under the tongue.

38. The method according to claim 32, wherein the orthotic includes a maxillary orthotic affixed to an upper surface of the orthotic conforming to the user's mandibular dentition.

39. The oral appliance according to claim 32, wherein the plurality of contours may include a contour placed on the orthotic near a bicuspid.

40. The oral appliance according to claim 39, wherein placing the contour near the bicuspid relieves discomfort in one or more of the following body areas: neck, upper back, hip, thigh, knee, elbow, forearm, wrist, hand and thumb.

41. The oral appliance according to claim 32, wherein the plurality of contours may include a contour placed on the orthotic near a cuspid.

42. The oral appliance according to claim 41, wherein placing the contour near the cuspid relieves discomfort in one or more of the following body areas: upper back, elbow, forearm, wrist, hand and thumb.

43. The oral appliance according to claim 32, wherein the plurality of contours may include a contour placed on the orthotic near a molar.

44. The oral appliance according to claim 43, wherein placing the contour near the molar relieves discomfort in one or more of the following body areas: skull, temple, eye, nasal and sinus symptoms, gagginess, reduction of throat dimension, neck, upper back, shoulder, thigh, knee, thumb.

45. The oral appliance according to claim 32, wherein the plurality of contours may include a contour placed on the orthotic near an incisor.

46. The oral appliance according to claim 45, wherein placing the contour near the incisor relieves discomfort in a posterior mid back region at a level of a diaphragm.

47. The oral appliance according to claim 32, wherein at least one contour is enlarged to allow the tongue to move freely in the user's mouth relieving pain stimulated in a head, a neck, a shoulder and/or an upper back of a user.

48. The oral appliance according to claim 1, wherein the plurality of contours relieve autonomic nervous system symptoms such as elevated heart rate, fatigue, on edge or stress like feelings, cold or warm hands and feet, digestive symptoms, visual changes, fight or flight effects, disturbed sleep, sinus and nasal dysfunctions.

49. The oral appliance according to claim 18, wherein the plurality of contours relieve autonomic nervous system symptoms such as elevated heart rate, fatigue, on edge or stress like feelings, cold or warm hands and feet, digestive symptoms, visual changes, fight or flight effects, disturbed sleep, sinus and nasal dysfunctions.

50. The oral appliance according to claim 32, wherein the contours relieve autonomic nervous system symptoms such as elevated heart rate, fatigue, on edge or stress like feelings, cold or warm hands and feet, digestive symptoms, visual changes, fight or flight effects, disturbed sleep, sinus and nasal dysfunctions.
